(19) United States
(12) Patent Application Publication
(10) Pub. No.: US 2026/0027706 A1
(43) Pub. Date: Jan. 29, 2026

(54) DYNAMIC STABILITY OF A ROBOT MANIPULATOR

(71) Applicant: Dyson Technology Limited, Malmesbury, Wiltshire (GB)

(72) Inventors: Edoardo FARNIOLI, Bristol (GB); Andreea RADULESCU, Bristol (GB); Giulio CERRUTI, Saint Laurent Du Var (FR)

(21) Appl. No.: 18/994,371

(22) PCT Filed: Jul. 13, 2023
(86) PCT No.: PCT/IB2023/057182

§ 371 Date: Jan. 14, 2025

(30) Foreign Application Priority Data
Jul. 15, 2022 (GB) 2210445.9

(51) Int. Cl. B25J 9/16; B25J 5/00

(52) U.S. Cl. CPC B25J 9/1633; B25J 5/007; B25J 9/162; B25J 9/1674

(57) ABSTRACT

A robot manipulator has a base; an arm connected to the base via at least a shoulder joint; and a control system with a dynamic stability determination module. The dynamic stability determination module of the control system determines whether a dynamic stability criterion is met. If the dynamic stability criterion is met, the arm is responds compliantly to an applied force; and if the dynamic stability criterion is not met, the control system causes motion of the base in the direction of the applied force.

### TECHNICAL FIELD OF THE INVENTION

The present invention relates to a robot manipulator comprising a control system which is configured to maintain stability through control of an arm of a robot and a base of the robot, depending on whether a stability criterion is met. Corresponding methods and computer-implemented methods are also covered.

### BACKGROUND TO THE INVENTION

3D cleaning devices may comprise robot manipulators having an attachment which is able to perform a particular cleaning task. Such manipulators are preferably able to move, using several moveable components, into positions in which the end-effector cleaning tool is correctly positions to clean e.g. a surface of an item of furniture or a floor. Because such devices may be used for home or commercial use it is likely that they will experience unexpected external forces (e.g. due to bumping into people or objects). In order to ensure the safety of such devices, it is of paramount importance that the devices are able to maintain dynamic stability in response to contacts either with an arm or a base of the robot manipulator. The present invention has been devised in view of this aim.

### SUMMARY OF THE INVENTION

In broad terms, the present invention relates to a robot manipulator which is configured to maintain stability through control of an arm, a base, or both. An arm of the robot manipulator may respond compliantly to an applied force, but if the applied force risks causing a loss of dynamic stability, a control system is configured to cause motion of the base, in order to regain stability. More specifically, a first aspect of the invention provides a robot manipulator comprising: a base; an arm connected to the base via at least a shoulder joint; and a control system, wherein: the control system is configured to determine whether a dynamic stability criterion is met; if the dynamic stability criterion is met, the arm is configured to respond compliantly to the applied force; if the dynamic stability criterion is not met, the control system is configured to cause motion of the base in the direction of the applied force. This dual control approach enables a high degree of stability to be achieved in response to an applied force.

In some cases, the control system may be configured to determine whether the dynamic stability criterion is met in response to an applied external force on the shoulder joint or the arm of the robot manipulator. Specifically, the robot manipulator may be configured to detect the presence of an applied force on the shoulder joint or the arm, and to determine whether the dynamic stability criterion is met in response to a detection of an applied force on the arm or the shoulder joint.

In some cases, if the dynamic stability criterion is met, the control system is configured to cause the arm to become compliant in response to the applied force.

The robot manipulator may further comprise a tower, which is connected at a proximal end to the base, and at a distal end to the shoulder joint. Herein, “tower” is used to refer to an upright component. The tower is preferably rigidly attached to the base, i.e. the relative position of the tower and the base is fixed. The presence of the tower raises the shoulder joint. The tower may be considered part of the base. By virtue of the shoulder joint, the arm may be pivotable and rotatable relative to the tower. Specifically, the shoulder joint may allow two kinds of movement: shoulder pitch and shoulder yaw. In the context of the present application, shoulder pitch refers to changing an angle between a longitudinal axis of the arm, and a longitudinal axis of the tower. Shoulder yaw refers to rotation of the arm about its longitudinal axis. Accordingly, the shoulder joint may include two sub-joints: a shoulder pitch joint and a shoulder yaw joint. This enables movement of the arm relative to the tower in the same manner that a human arm is able to move at the shoulder.

The control system may comprise a dynamic stability determination module which is configured to determine whether the dynamic stability criterion is met. In the context of the present application, dynamic stability refers to stability of the robot manipulator against toppling or falling when the robot is moving. This is contrast to static stability, which refers stability of the robot manipulator against toppling when stationary. Determination of whether the dynamic stability criterion is met may take place continuously, or at fixed time intervals. For example, in some implementations, the determination may take place at least once per second, at least once ten times per second, at least fifty times per second, or at least seventy-five times per second. The determination may take place no more than one thousand times per second, no more than five hundred times per second, no more than two hundred and fifty times per second, or no more than one hundred and fifty times per second. In a preferred case, the determination may take place approximately one hundred times per second. To clarify, the determination may take place continuously or at fixed time intervals regardless of whether there is an applied external force on the arm or the shoulder joint of the robot manipulator. In other words, the determination may take place continuously or at fixed time intervals when there is no applied external force, or, in response to an applied external force on the arm or the shoulder joint of the robot manipulator, the determination may begin, either continuously or at fixed time intervals.

In response to a determination whether the dynamic stability criterion is met, the control system may be configured to generate instructions, which when executed by the arm or the base, cause them to execute the motion required. The arm may comprise an arm motion system which is configured to receive the instructions, and to execute the specified arm motion. Similarly, the base may comprise a base motion system which is configured to receive the instructions, and to execute the specific base motion. The arm motion system is preferably located at the shoulder joint, such that the arm motion system is configured to cause motion of the shoulder joint (i.e. the shoulder pitch joint and/or the shoulder yaw joint) in order to cause the arm to execute the desired motion. In response to the instructions, the arm motion system may be configured to control a proportional and derivative (PD) gain of the shoulder joint (i.e. the shoulder pitch joint and/or the shoulder yaw joint), in order to control the compliance of the arm. Herein, the term “compliant” means that the arm responds to an applied force by moving in the direction of that force with little or no active resistance provided by the robot. There may be minimal resistance such as intrinsic friction in the shoulder joint, but the robot manipulator does not actively resist the movement. Specifically, in response to an instruction to become compliant, the controller may be configured to decrease the PD gain, thereby increasing the compliance at the arm. In this way, in response to an applied force at the arm which does not lead to a failure to meet the dynamic stability criterion, the arm becomes compliant and effectively follows the motion caused by the applied force, thereby neutralizing the effect of the force. The arm motion system may comprise an impedance controller for this purpose. Alternatively, the arm motion system may comprise an admittance controller.

The control system, or the dynamic stability determination module thereof, may be configured to determine a zero-moment point (herein, “ZMP”) of the robot manipulator. Then, the control system, or the dynamic stability determination module thereof, may be configured to determine whether the dynamic stability criterion is met based on the location of the ZMP of the robot manipulator. The term “ZMP” is well-defined in the technical field of robotics and stability, and refers to the point where the horizontal component of the moment of the ground reaction force becomes zero. On flat surfaces, it coincides with the centre of pressure (CoP), which represents the location of an equivalent force equal to the integral of the pressure distribution under the support surface. The control system or the dynamic stability determination module may comprise a ZMP determination module for this purpose. Having defined and determined the ZMP, we now discuss the specific nature of the dynamic stability criterion in this context. The dynamic stability criterion may be that the ZMP of the robot manipulator is located above a predetermined support region, the predetermined support region being bounded by a predetermined support region boundary. Alternatively, the dynamic stability criterion may be that the ZMP of the robot manipulator is located above a point within the predetermined support region which is at least a threshold distance from the predetermined support region boundary. The predetermined region is defined in a plane, preferably e.g. the plane of the floor on which the robot manipulator is standing. “Above” here should be understood to me “vertically above”. In the context of the present invention, the predetermined support region is preferably a region which is defined by e.g. a user of the robot manipulator. In contrast, a dynamic stability region may be defined as a region over which the ZMP must be located in order for the robot manipulator to be dynamically stable against tipping or tilting. In other words, the dynamic stability region is defined by the geometry, statics, and dynamics of the robot manipulator, whereas the predetermined support region is a region which is selected by a user. The dynamic stability region is preferably bounded by a dynamic stability region boundary, and the predetermined support region does not extend outside the dynamic stability region boundary. In this way, it is guaranteed that the robot manipulator is dynamically stable when the ZMP is located above any point in the predetermined support region.

In a particular implementation, the base may comprise one or more floor-contacting supports. The supports may be in the form of wheels, or feet, for example. In such cases, the dynamic stability region may be defined by the one or more floor-contacting supports, specifically by the location thereof. It is preferable that the base comprises three or more floor-contacting supports, the contact points of the floor-contacting support with the floor defining a support polygon region. Preferably, the support polygon region is the polygon formed by connecting the contact points of the floor-contacting supports with a number of straight lines equal to the number of floor-contacting supports, to form a polygon. Preferably, the support polygon is a convex polygon (i.e. one in which all internal angles are less than 180°). When the ZMP is located at any point inside such a polygon, the robot manipulator will be dynamically stable. The predetermined support region is preferably defined to be a circular region which is inscribed within the support polygon region. By having a circular predetermined support region, it is possible to maintain dynamic stability using homogeneous responses which are independent of the direction of motion of the ZMP, and based only on its position. The circular region is preferably the largest circle which can be wholly inscribed within the support polygon region, thereby maximizing the size of the predetermined support region within the dynamically stable region. In a preferred implementation, the base may comprise three floor-contacting supports, defining a support triangle region. In this case, the predetermined support region is preferably the incircle of the support triangle region, where “incircle” is used to refer to the largest circle which may be inscribed within a given triangular region. The floor-contacting supports are preferably circumferentially evenly spaced about a central longitudinal axis of the base (e.g. an axis perpendicular to the floor), such that the support polygon is a regular polygon, e.g. an equilateral triangle in the case where there are three floor-contacting supports.

We now consider what the above means for the control of the robot manipulator, specifically the case in which the predetermined support region is the inscribed circle of a support polygon, and the dynamic stability criterion is that the ZMP is located above a point within the predetermined support region which is at least a threshold distance from the predetermined support region boundary. In this case, the dynamic stability criterion is effectively that the ZMP is located above a predetermined circular region, the radius of the predetermined circular region being smaller than the radius of the inscribed circle. In response to an applied force, if the ZMP remains within the predetermined circular region, the robot manipulator maintains dynamic stability by causing the arm to become compliant, thereby neutralizing the effect of the applied force. However, if the applied force is such that it may cause the ZMP to move outside the predetermined circular region, the robot manipulator causes motion of the base to restore stability. In this way, the robot manipulator is able to act pre-emptively if the applied force risks a loss of stability, prevent the loss of stability from ever occurring.

The shoulder joint may be located at a proximal end of the arm. The robot manipulator may further comprise an end-effector located at a distal end of the arm, opposite from the proximal end. The end-effector is preferably connected to the distal end of the arm via a wrist joint. The wrist joint may have one or two degrees of freedom. For example, the wrist joint may comprise a wrist pitch joint and a wrist yaw joint, with “pitch” and “yaw” having the same definitions as set out earlier. In some cases, the wrist joint may comprise only one of a wrist yaw joint and a wrist pitch joint, though.

The control system may be configured to receive target trajectory instructions defining a target trajectory of the end-effector. The control system may then be configured to control the motion of one or more of the base, the shoulder joint (either or both of the shoulder pitch joint or the shoulder yaw joint thereof), and the wrist joint (either or both of a wrist pitch joint or a wrist yaw joint thereof) in order to cause the end-effector to execute the target trajectory. The control system may, specifically, be configured to generate: first instructions defining target motion of the shoulder joint (either or both of the shoulder pitch joint or the shoulder yaw joint thereof); and second instructions defining the target motion of the base, such that execution of the target motion of the shoulder joint according to the first instructions and execution of the target motion of the base according to the second instructions causes the end-effector to execute the target trajectory as defined in the target trajectory instructions. In some cases, the control system may be further configured to generate third instructions defining the target motion of the wrist joint (either or both of the wrist pitch joint or the wrist yaw joint thereof), such that execution of the target motion of the shoulder joint according to the first instructions; execution of the target motion of the base according to the second instructions; and execution of the target motion of the wrist joint according to the third instructions causes the end-effect to execute the target trajectory as defined in the target trajectory instructions. As discussed, motion of the shoulder is preferably controlled by an impedance controller; accordingly, the first instructions are preferably in the form of a shoulder joint torque command. The motion of the base is preferably controlled by an admittance controller; accordingly, the second instructions are preferably in the form of a base velocity command. The third instructions may be in the form of a wrist torque command, since the motion of the wrist joint is also preferably controlled by an impedance controller. The instructions are preferably generated through inverse kinematics¹, i.e. by determining the values of joint parameters in order to allow the end-effector to execute the target trajectory. Execution of the instructed commands is preferably effected by motion systems located at the joints. ¹https://motion.cs.illinois.edu/RoboticSystems/InverseKinematics.html

The priority of the system is to ensure dynamic stability of the robot manipulator. Specifically, in response to an applied force at the arm, the system prioritizes maintaining dynamic stability over execution of the target trajectory. Execution of the target trajectory is only prioritized if there is no applied force, or if the applied force is negligible. Accordingly, in response to the detection of the applied force, the control system is preferably configured to determine whether the applied force exceeds a magnitude threshold. If the control system determines that the magnitude of the applied force does not exceed the magnitude threshold, the control system may then be configured to control the motion of one or more of the base, the shoulder joint (the shoulder pitch joint and/or the shoulder yaw joint thereof), or the wrist joint (the wrist yaw joint and/or the wrist pitch joint thereof) to cause the-effector to execute the target trajectory. If the control system determines that the magnitude of the applied force exceeds the magnitude threshold, then the control system may be configured to determine whether the dynamic stability criterion is met, as outlined above.

We now discuss in more detail the control of the base of the robot manipulator. The motion of the base may be influenced by one or more of a need to restore stability (i.e. by counteracting the motion of the ZMP in response to e.g. an applied force on the arm), a need to respond to an external force applied to a base, and obeying the second instructions to ensure that the end-effector executes the target trajectory defined in the target trajectory instructions. In order to decide which of these factors should inform the motion of the base, it is preferable to be able to compare three like quantities. Accordingly, the control system may be configured to determine a force value which is associated with each. It should be noted that the following determinations may be carried out when there is no applied force, when there is an applied force on the arm only (i.e. the shoulder joint, arm, wrist joint, or end-effector), when there is an applied force on the base only, or when there is an applied force on the base and an applied force on the arm. The control system may be configured to determine a virtual ZMP force, which is a force which, which when applied to the base, would either counteract any motion of the ZMP, or act to move the ZMP back to within the predetermined support region. The control system may be configured to determine an external force applied to the base. The external force on the base may be a result of a combination of a plurality of externally applied forces. In order to determine the external force, the robot manipulator, or the control system thereof, may comprise one or more force or torque sensors. These may be located in an actuator. The control system may be further configured to determine an effective force which, when applied to the base, would cause the base to execute the target motion according to the second instructions.

The portion of the control system which controls the motion of the base (e.g. the base motion system, or an admittance controller), preferably receives an input target force, and is configured to convert the input target force into a base velocity command. It should be noted that the base velocity command does not necessarily correspond to the second instructions, since the second instructions assume the absence of any applied force (or a negligible applied force). When executed by e.g. a motion system of the base, the base velocity command causes the base to execute a target motion, which takes into account one, two, or all of the forces calculated by the control system.

The control system preferably comprises a force selector, which is configured to receive data defining the virtual ZMP force, the external force on the base, and the effective force. The force selector may then be configured to determine a target force (which forms the input target force referred to above). In some cases, the force selector may select a single one of the three forces. In other cases, the force selector may be configured to determine the target force based on a weighted sum of the three forces. The weighted sum is preferably a vector sum of the forces.

As discussed, the priority is the maintenance of dynamic stability. Accordingly, the force selector may be configured to prioritize the virtual ZMP force, the external force applied to the base, then the effective force, when determining the target force. Specifically, the force selector may operate according to the following scheme. If the virtual ZMP force exceeds a first threshold, the force selector is configured to select the virtual ZMP force; if the virtual ZMP force does not exceed the first threshold, if the external force applied to the base exceeds a second threshold, the force selector is configured to select the applied force on the base; and if neither the virtual ZMP force exceeds the first threshold nor the external force applied to the base exceeds the second threshold, the force selector is configured to select the effective force.

In other cases, a first parameter may define the extent to which the ZMP is located outside either the predetermined support region, or outside e.g. the predetermined circular region within the predetermined support region. Clearly, the greater the value of the parameter, the more urgent the need for the lack of stability to be addressed. Specifically, when the ZMP is located outside the predetermined support region, the value of the parameter is preferably 1. When the ZMP is located at least a predetermined distance from the predetermined support region boundary (e.g. inside the predetermined circular region when the predetermined support region boundary is an inscribed circle), the value of the first parameter may be 0, because the ZMP is sufficiently far from a position where dynamic stability may be at risk that there is no need to address it. When the ZMP is located within a threshold distance of the predetermined boundary support region, the first parameter preferably takes a value between 0 and 1, the value corresponding to the distance between the ZMP and the predetermined threshold distance from the predetermined support region boundary, more specifically preferably a radial distance. This distance value may be divided by a radial distance between the predetermined threshold distance and the boundary of the predetermined support region to give the first parameter. The correspondence may be linear, or may take a more complex functional form. The first parameter may be referred to as a.

A second parameter may define the extent to which the external force applied to the base exceeds a first external force threshold. When the force does not exceed the first external force threshold, the value of the second parameter is preferably 0. When the external force applied to the base exceeds a second external force threshold, greater than the first external force threshold, the value of the second parameter is preferably 1. And, when the external force is between the first external force threshold and the second external force threshold, the value of the second parameter is between 0 and 1. The correspondence, again, may be linear, or may take a more complex functional form. The second parameter may be proportional to the difference between the measured force and the first force threshold (more specifically, the extent to which the measured force exceeds the first force threshold). This difference may optionally further be divided by a difference between the first and second force thresholds to give the second parameter. The second parameter may be referred to as β.

In these cases, the target force \hat{F} calculated by the force selector may be as follows:

$$\hat{F} = α \cdot {\hat{F}}_{ZMP} + ( 1 - α ) ( 1 - β ) {\hat{F}}_{rtrn} + β ( 1 - α ) {\hat{F}}_{ext}$$

In which \hat{F}_{ZMP} is the virtual ZMP force, \hat{F}ᵣₜᵣₙ is the effective force, and \hat{F}ₑₓₜ is the external force applied to the base. A detailed explanation of this formula, and how it achieves the desired effects, is set out later in this patent application.

The control system may further comprise a stability aware acceleration module, configured to receive the generated velocity command, and to determine whether motion of the base according to the base velocity command will give rise to a lack of stability. If so, the stability aware acceleration module may be configured to modify the base velocity command, thereby generating a modified base velocity command which, when executed, will not give rise to a lack of stability. Preferably, this is achieved by reducing the magnitude of the command.

The robot manipulator of the present invention is preferably a 3D cleaning device. Accordingly, the end-effector may comprise one or more of the following: a vacuum cleaning attachment, a mopping attachment, a brush, or a wiper. Any cleaning attachment is envisaged for use with the invention.

The preceding disclosure is directed towards a robot manipulator, or a 3D cleaning device comprising the robot manipulator. In both of these cases, the robot manipulator comprises a control system. That control system executes the control method which gives rise to advantages over known systems. Accordingly, a further aspect of the invention may provide a control system as outlined previously.

Specifically, a further aspect of the invention may provide a control system for a robot manipulator, the robot manipulator comprising a base and an arm connected to the base via at least a shoulder joint, the control system comprising a dynamic stability determination module, wherein the dynamic stability determination module of the control system is configured to determine whether a dynamic stability criterion is met; if the dynamic stability criterion is met, arm is configured to respond compliantly to the applied force; and if the dynamic stability criterion is not met, the control system is configured to cause motion of the base in the direction of the applied force. The optional features set out previously, in respect of the first aspect of the invention, also apply equally well to the control system of the further aspect of the invention, except where clearly incompatible or where content dictates otherwise.

Another aspect of the invention may provide a method, or computer-implemented method of controlling a robot manipulator comprising a base and an arm connected to the arm via at least a shoulder joint (or a 3D cleaning device comprising such a robot manipulator). Such a method may comprise the steps of: determining whether a dynamic stability criterion is met; if the dynamic stability criterion is met, the arm responding compliantly to the applied force; and if the dynamic stability criterion is not met, causing motion of the base in the direction of the applied force. Additional aspects of the invention provide a computer program product containing instructions which when executed by a computer, or a processor of a computer, cause it to execute the computer-implemented method of the previous aspect of the invention. A further aspect provides a computer-readable medium storing the computer program product of the previous aspect of the invention. For the avoidance of doubt, the optional features set out in respect of the first aspect of the invention apply equally well to all subsequent aspects of the invention, except where clearly incompatible or where context dictates otherwise.

### BRIEF DESCRIPTION OF THE DRAWINGS

Embodiments of the present invention will now be described with reference to the accompanying drawings, in which:

FIG. 1 shows a robot manipulator.

FIG. 2 is a diagram illustrating a support triangle with inscribed circular regions.

FIG. 3A is a high-level flowchart illustrating a stability aware acceleration process.

FIG. 3B shows results demonstrating the effectiveness of the stability aware acceleration process.

FIG. 4A is a high-level flowchart illustrating a push handling process.

FIG. 4B is comparison of the action of an ordinary comparator (A) and a Schmitt trigger (B) on a noisy input signal (U). The green dotted lines are the circuit's switching thresholds. The Schmitt trigger tends to remove the effect of noise form the signal.

FIG. 4C shows the correlation between base target velocity (top) and ZMP/CoP location (bottom) during a push: when the CoP is within the inner circle C2 (Phase 1) the base velocity is reduced to a stop, while when its location moves to the zone between the inner circle C2 and the outer circle C1 (Phase 2), the vase velocity is modulated to bring the system back into the more stable configuration (Phase 1). The band around the Phase 1 stability limit denotes the Schmitt trigger switching region.

FIG. 5 shows admittance controller operation: the base velocity commands (top) in response to the detected external forces (middle) and the corresponding admittance mode (bottom) of the finite state machine (FSM) of the admittance controller.

FIG. 6 is a control scheme for integration of push handling strategies involving a rotational response of the base.

FIG. 7 shows a general control scheme incorporating push handling at the arm and the base.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

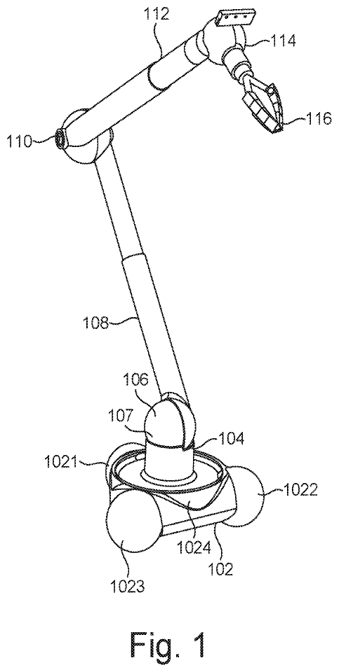

The purpose of the present invention is to provide a robot manipulator which is able to perform housekeeping operations. In that context, the platform is required to navigate and manipulate objects in the home (which is a highly unstructured environment), in a considerate and reliable way. The platform must therefore have an adequate reachability area, but be lithe enough to navigate the environment. An example of a robot manipulator is shown in FIG. 1. The robot manipulator 100 comprises, broadly, a base 102, a tower 104, a first joint 106, an upper arm 108, a second joint 110, a lower arm 112, a third joint 114, and an end-effector 116 in the form of a grabbing tool. It should be noted that in implementations of the present invention, the end-effector 116 may comprise a cleaning tool, as outlined elsewhere in this application. It should also be noted that the robot manipulator 100 shown in FIG. 1 is an illustrative example only, and simpler arrangements comprising e.g. only a base and an arm connected by an elbow joint are also considered by the scope of the invention. The base 102 is in the form of a holonomic platform comprising three wheels 1021, 1022, 1023. The holonomic platform can preferably change the direction of motion without having to perform intermediate rotation steps. It can preferably move in all directions from a given starting point while simultaneously rotating. In general, the control of such mobile platforms may be based on kinematic models. By using direct and inverse kinematics, it is possible to pass from wheel space to Cartesian space and vice versa. Hence, the base 102 can be driven simply in function of its translational and rotational speeds. This conversion may be obtained through the definition of a map.² It is possible to drive the base 102 according to the error between the target base twist (linear and angular velocities) and the extrapolated one from wheel velocity movements (normally the derivative of motor encoders). Target velocities may be computer according to a target configuration and a current configuration. ²Chapter 13—Lynch, K. & Park, F. (2006) Book—Modern Robotics. In Robotica (Issue May)

The wheels 1021, 1022, 1023 are connected to a central cylindrical hub 1024. Tower 104 is mounted to an upper surface of the cylindrical hub 1024. In some cases, the tower 104 may be able to rotate relative to the central cylindrical hub 1024, but in other cases, the tower 104 may be fixed relative to the central cylindrical hub. In implementations in which the tower 104 is fixed relative to the upper surface of the central cylindrical hub 1024, the two may be integrally formed. An upper end of the tower 104 is connected to an upper end of the upper arm 108 via first joint 106, which may be referred to herein as a shoulder joint 106, which allows free rotation of the upper arm 108 relative to the tower 104. Specifically, the shoulder joint 106 comprises a ball 107 which is free to rotate in a socket defined in the top of the tower 104. The upper arm 108 may further be configured to rotate about its longitudinal axis. The lower end of the upper arm 108 is connected to an upper end of the lower arm 112 via second joint 110, which may be referred to as an elbow joint 110 or hinge join 110. Then, the lower end of the lower arm 112 is connected to the end-effector 116 via third joint 114, which may be referred to as a wrist joint 114. The end-effector 116 may both pivot relative to the lower arm 112, and also rotate about its longitudinal axis.

Due to the wide range of tasks and scenarios involved, the stability of the system is closely related to the mobile base 102 motion, the arm (e.g. upper arm 108 or lower arm 112) motion and external disturbances applied to the base 102. These three factors must be considered in order to ensure an autonomous stable robot manipulator 100. There are three areas of stability in light of which the present invention has been devised:
(i) Stability-aware acceleration in 3D: bases of robotic manipulators traditionally rely on velocity control while navigating. Without proper planning, target velocities can induce large accelerations which might destabilize the platform, ultimately leading it to fall. It is therefore important to determine the limits of admissible acceleration and constrain it in order to preserve stability.
(ii) Push handling: because the robot manipulator 100 is expected to operate even in the presence of users, unexpected contacts, with both objects and people, are likely to occur. In this case, the system is required to handle these physical interactions in a robust way (i.e. avoiding damage and/or injuries) while maintaining stability. As we will explain, the response may require moving just the arm 108, 112, or the base 102, but also the whole robot manipulator 100.

In order to ensure dynamic stability, the robot manipulator 100 is preferably able to determine where on its surface an accidental contact between user and robot manipulator 100 has takes place (i.e. whether it is on an arm 108, 112, or on the base 102). The robot manipulator 100 may further be able to move e.g. an arm 108, 112, or the base 102, in order to avoid unwanted interactions, and to maintain stability when such a contact occurs. It is also important that the processes used to achieve both of these abilities are compatible with each other.

In preferred implementations of the present invention, the stability criterion which is used to monitor the dynamic stability of the robot manipulator is the zero-moment point³ (referred to herein as the “ZMP”). In order to simplify the dynamics of the system, a linear inverted pendulum model (LIPM) may be used. The ZMP may be defined as the point where the horizontal component of the moment of the ground reaction force becomes zero. On flat surfaces, it coincides with the centre of pressure (CoP), which represents the location of an equivalent force equal to the integral of the pressure distribution under the support surface. In the case of the robot manipulator 100, the base 102 represents the support surface at which contact with the ground takes place. According to the specific implement herein describes, the stability criterion states that the ZMP must be constrained within the convex-hill of the foot-support area to ensure the stability of the foot ground contact⁴. In practice, the ZMP is preferably maintained within a subset of the support polygon, since a ZMP location at the edge of the support polygon could lead to an unstable configuration. The LIPM makes it possible abstractly to represent the upper robot structure (i.e. the upper arm 108, the lower arm 112, the end-effector 116, and the intervening joints 106, 110, 114) in order to provide a computer-implemented control method which simplifies the robot kinematics. In this manner, the time evolution of the robotic system may be represented as the movement of an inverted pendulum, with a constraint such that the mass moves along an arbitrary defined plane. ³Vukobratović, Miomir, and Branislav Borovac. “Zero-moment point—thirty-five years of its life.” International journal of humanoid robotics 1.01 (2004): 157-173.⁴Arakawa, Takemasa, and Toshio Fukuda. “Natural motion generation of biped locomotion robot using hierarchical trajectory generation method consisting of GA layers.” Proceedings of International Conference on Robotics and Automation. Vol. 1. IEEE, 1997

When a robot manipulator such as the robot manipulator 100 operates in an unstructured environment or shares its workplace with a human user, safety issues are a primary concern. Anticipating incipient collisions or detecting them in real-time is typically based on the use of additional external sensors. Once a collision is detected, the controller may switch from a strategy of causing the robot to move along its target trajectory, to a strategy in which the motion of the robot manipulator 100 is stopped, or to perform a more sophisticated interaction task. In Kim et al. (2016)⁵ a push handling strategy for a statically stable mobile base is presented. The authors use joint level torque sensing instead of inertial measurement sensing to determine the direction and magnitude of the pushing forces. IMU accelerometers can only detect external forces once static friction is overcome, leading to a less sensitive external force detection. ⁵Kim, Kwan Suk, Travis Llado, and Luis Sentis. “Full-body collision detection and reaction with omnidirectional mobile platforms: a step towards safe human-robot interaction.” Autonomous Robots 40.2 (2016): 325-341.

Comparing the applied torque (or the current in an electrical drive) with the nominal model-based command (i.e. the torque expected in the absence of a collision) and looking for fast transients to detect possible collision is a possible scheme. However, a common drawback (even when the robot dynamics are perfectly known) is that the on-line torque computation based on inverse dynamics requires acceleration measurements, which introduces noise. In De Luca et al. (2005)⁶, collisions are detected using only standard joint encoders. ⁶De Luca, A., & Mattone, R. (2005). Sensorless robot collision detection and hybrid force/motion control. Proceedings—IEEE International Conference on Robotics and Automation, 2005 (April), 999-1004. https://doi.org/10.1109/ROBOT.2005.1570247

Both admittance and impedance controllers make it possible to generate a compliant behaviour with a rigid robot manipulator 100. The main difference between admittance control and impedance control is that the former controls motion after a force is measured, and the latter controls force after motion or deviation from a set point is measured. Because most mobile bases, such as base 102 are controlled in velocity, an admittance controller approach has been traditionally employed to implement compliant behaviour in these platforms^{4,7}. ⁷Dietrich, Alexander, et al. “Whole-body impedance control of wheeled mobile manipulators.” Autonomous Robots 40.3 (2016): 505-517.

There are two degrees of freedom of movement at the first joint 106 (which may alternatively be referred to as shoulder joint 106). The shoulder joint 106 comprises two joint axes, the first joint axis (the shoulder yaw) is parallel to the tower, while the second joint axis (the shoulder pitch) is orthogonal to the first joint axis. The axes of the elbow joint 110 and the wrist joint 114 are parallel to the second joint axis.

We now discuss in more detail the computation and monitoring of the dynamic stability criterion. In order to determine the location of the CoP (in this case, equivalent to the ZMP), the robotic manipulator 100 may comprise a plurality of load and/or pressure sensors, which are preferably located in a position which is beneath the tower 104. It is preferable that the number of weight sensors is greater than or equal to the number of points of contact of the base 102 with the ground, when the robot manipulator 100 is in a working configuration (i.e. upright, and supported by the points of contact, the three wheels 1021, 1022, 1023 in this case). Specifically, it is preferable that there is a weight sensor associated with each of the points of contact, e.g. a weight sensor associated with each of the wheels 1021, 1022, 1023. Preferably, the weight sensors are distributed circumferentially evenly around a central axis of the central cylindrical hub 1024. In the three-wheeled arrangement, the weight sensors are preferably located at 120° from each other about the central axis of the central cylindrical hub.

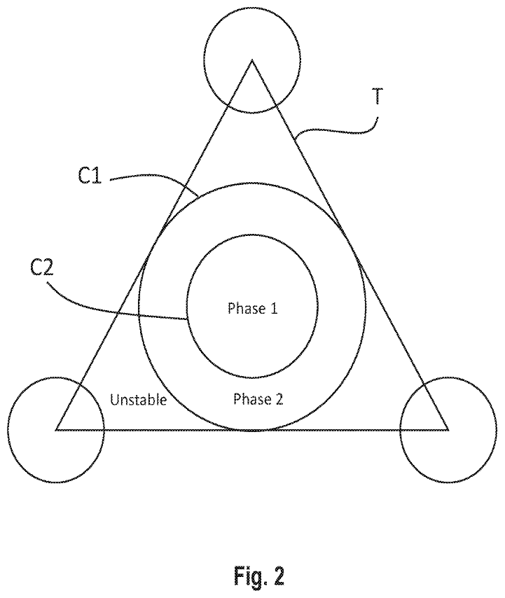

FIG. 2 shows a horizontal section of a base 102 of a robot manipulator 100 such as the robot manipulator 100 of FIG. 1, in an initial static state. In this state, the centre of mass (CoM) and the centre of pressure (CoP) coincide. In FIG. 2, the support polygon is represented by the outermost triangle T. The stability criterion states that if the CoP lies within the support polygon T, the platform is dynamically stable. To ensure dynamic stability, the system is preferably configured to maintain a positive stability margin, defined herein as a distance between the CoP (or ZMP) and the closest edge of the support polygon. For simplicity, it is preferred to define the support polygon as an outer circle C1 which is inscribed within the triangle T. These preserves homogeneous reaction behaviours independent from the direction of motion of the CoP (or ZMP) of the robot manipulator 100 and based only on its position. An inner circle C2, concentric with, and having a smaller radius than the outer circle C1 is also defined. The inner circle C2 represents a zone in which the safety margin is above a predefined stability threshold.

Based on the position of the CoP (or ZMP) relative to the triangle T, outer circle C1, and inner circle C2, three states may be defined:
(i) Phase 1: the CoP (or ZMP) is located within the inner circle C2.
(ii) Phase 2: the CoP (or ZMP) is located within the outer circle C1, but not within the inner circle C2.
(iii) Unstable: the CoP (or ZMP) is located outside the outer circle C1, i.e. outside the stability region.

It is worth noting that when the CoP is outside the outer circle C1, but still inside the triangle T, the platform is still dynamically stable, but for the purposes of homogeneity (as discussed above) this is defined as an “unstable” condition.

We now discuss stability-aware acceleration and push handling in turn.

### Stability-Aware Acceleration

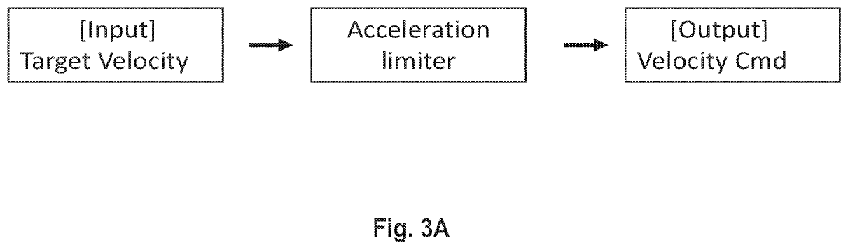

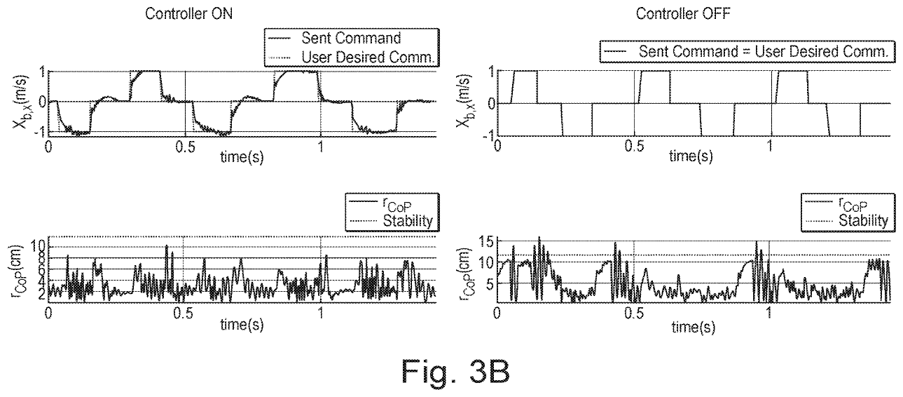

Navigation control of robot manipulators such as robot manipulator 100 traditionally relies on velocity control, but without proper constraints in place, large accelerations can lead to instabilities, and ultimately toppling. When the robot manipulator 100 (specifically the base 102 thereof) starts accelerating, the position of the ZMP evolves in the opposite direction. It is therefore important to determine what the admissible accelerations of the base 102 are, in order to prevent the ZMP from moving outside the stability region. A high-level flowchart illustrating the process by which this achieved is shown in FIG. 3.

As discussed previously, the robot manipulator 100 may be modelled using a Linear Inverted Pendulum Model (LIPM), this enables abstraction of the upper robot structure, in a manner which subsequently enables a control method with simpler robot kinematics. In the following example, the scenario is considered in which the mobile base 102 is able to move freely on a surface plane.

In discrete time, the system may be defined as follows:

$${X}_{b} ( k + 1 ) = [ \begin{matrix}1 + w \frac{\text{?}}{2} & \text{?} + w \frac{\text{?}}{6} & - w \frac{\text{?}}{2} \\ 1 + w \frac{\text{?}}{2} & \text{?} + w \frac{\text{?}}{6} & - w \frac{\text{?}}{2} \\ w \text{?} & 1 + w \frac{\text{?}}{2} & - w \text{?} \\ w \text{?} & 1 + w \frac{\text{?}}{2} & - w \text{?} \\ 0 & 0 & 1 \\ 0 & 0 & 1\end{matrix} ] {X}_{b} ( k ) + [ \begin{matrix}- w \frac{\text{?}}{6} \\ - w \frac{\text{?}}{6} \\ - w \frac{\text{?}}{2} \\ - w \frac{\text{?}}{2} \\ \text{?} \\ \text{?}\end{matrix} ] u ( k )$$

$$\text{?} \text{indicates text missing or illegible when filed}$$

Herein, X_{b} is defined as follows:

$${X}_{b} = [ \begin{matrix}{CoM}_{x} \\ {CoM}_{y} \\ \dot{{CoM}_{x}} \\ \dot{{CoM}_{y}} \\ {p}_{x} \\ {p}_{y}\end{matrix} ]$$

Herein, w is also defined as follows:

$$w = \frac{g}{{CoM}_{𝓏}}$$

Tₛ is defined as the control loop time. pₓ and p_{y} describe the location of the ZMP on the plane of the support polygon. The control input u represents the velocity of the ZMP. The 2D LIMP model is used to compute the ZMP of the system in the discrete domain. The CoM in this scenario refers to the who system (including the base and arm parts), hence the stability is ensured at the whole-body level. The control strategy in the present example delivers the command for the motors at the mobile base. No arm movement strategy is employed in this scenario.

$${X}_{b} ( k + 1 ) = {AX}_{b} ( k ) + Bu ( )$$

$$p ( k ) = {CX}_{b} ( k )$$

$${X}_{b} ( k ) = {[ {CoM}_{x} ( kt ) , {CoM}_{y} ( kt ) , C \dot{o} {M}_{x} ( kt ) , C \dot{o} {M}_{y} ( kt ) , C \ddot{o} {M}_{x} ( kt ) , C \ddot{o} {M}_{y} ( kt ) , ]}^{T}$$

$$u ( k ) = {[ {u}_{x} ( kt ) , {u}_{y} ( kt ) ]}^{T}$$

$$p ( k ) = {[ {p}_{x} ( kt ) , {p}_{y} ( kt ) ]}^{T}$$

Given the stability margins p_{LIM} and the current state X_{b}(k), the next step maximum admissible accelerations are computed from the dynamics equations. Then, the maximum admissibly command u_{LIM}(k) is obtained. This is used to clamp the high-level control signal u_{des}(k), defined either by the user or an external planner, to ensure stability.

This approach not only eliminates unstable accelerations that may cause the platform to tilt and fall, but also removes unwanted jittery behaviours and allows for smoother, more fluid navigation behaviour.

Using the definitions above, the ZMP/maximum admissible linear accelerations dependencies are obtained as:

$${CoM}_{x , LIM} = ( CB ) - 1 ( {p}_{LIM} - ( CA ) {CoM}_{x} )$$

$${CoM}_{y , LIM} = ( CB ) - 1 ( {p}_{LIM} - ( CA ) {CoM}_{y} )$$

The model described so far only handles the linear movement of the ZMP, but the mobile base platform is also affected by rotational forces. In order to ensure that the angular movement will not cause the ZMP to exit the stable region, a maximum permissible angular acceleration command \ddot{θ}_{LIM} may be imposed, and used to claim the high-level control signal u.

FIG. 3B shows a comparison of the movement of the ZMP under a user defined velocity command (using a joystick) with a maximum admissible acceleration module ON (right) and OFF (left), respectively, obtained from a robot manipulator similar to the robot manipulator shown in FIG. 1. When the module is deactivated, the user desired command is passed on directly to the motors which can bring the ZMP to instability (edge of the support region and beyond). With the module active, the instantaneous velocity command is restricted within the range that would not lead to instability.

### Push Handling

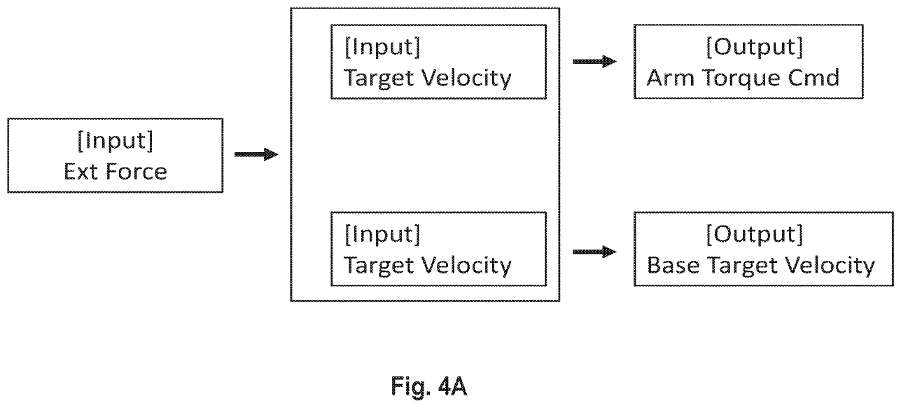

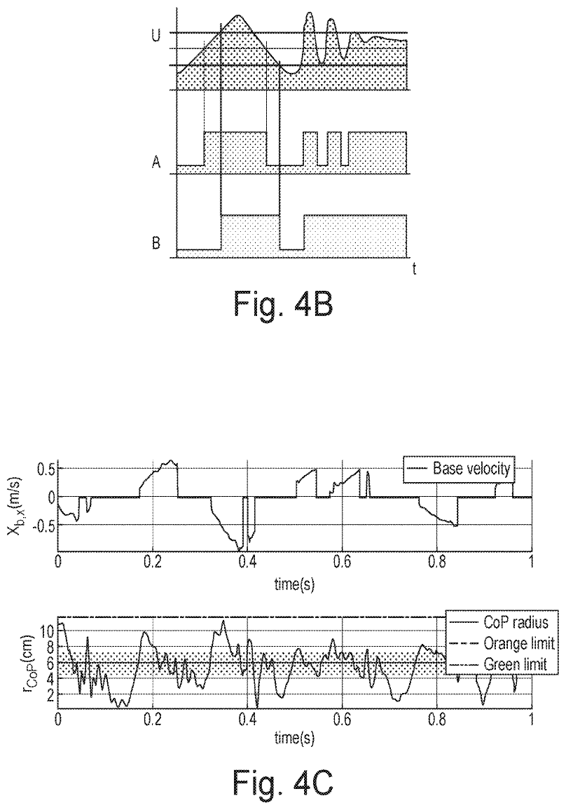

As discussed, the robot manipulator 100 is expected to operate in household environments, where unexpected contacts are inevitable. It is necessary to maintain stability while handling these interactions in a manner whereby damage and/or injuries are avoided. The platform needs to be compliant in order to reduce the risk of injury. The response may require moving just the base 102, moving one or more of the arms 108, 112, or moving the whole robot manipulator 100. The external forces applied to the robot manipulator 100 may be divided into two categories: those which affect the stability of the robot manipulator 100, and those which do not affect the stability of the robot manipulator 100. The former is preferably handled by compensating any deviation from the stable ZMP target (i.e. by controlling the motion of the base 102, the arms 108, 122, or the whole robot manipulator 100, to ensure that the ZMP “moves” to within the stability region). The latter case is preferably moving the whole robot manipulator 100 away from the direction of the applied force. This strategy relies on generating a compliant behaviour in the system, in the presence of an unexpected applied external force. It relies on a multi-stage approach, dependent on the magnitude of the disturbance. FIG. 4 is a flowchart showing a high-level approach by which applied forces on the robot manipulator 100 may be dealt with. In the absence of any external forces, both the arm(s) 108, 112, and the base 102, are controlled, by respective admittance or impedance controllers, to track a given target position (which may be a single pose, or a trajectory, provided by an external planner).

We first discuss the process by which a push on the arms 108, 112 is dealt with. Preferably a controller of the robot manipulator 100 is configured to apply a control algorithm to sensor data indicative of an applied external force on the robot manipulator 100 (specifically to the arms 108, 112 thereof). A two-step strategy may be employed. Firstly, the robot manipulator 100 may react by accommodating the physical interaction through virtual compliance in the arms 108, 112. If the applied forces threated stability of the robot manipulator 100, additional motion of the base 102 may also be employed. In the example presently described, disturbances on the arms 108, 112 are handled by an impedance controller, which is configured to make the arms 108, 112 behave like a mass-spring-damper system, the mechanics of which are well understood. This introduces a virtual compliance in the arms 108, 112, which reduces impacts and filters contact forces. The impedance controller is preferably always active, independently from a determined state of the robot manipulator 100.

The arm may be modelled as a 4 degrees-of-freedom robot manipulator 100, as described previously. The robot manipulator 100 may be equipped with sensors, such as force-torque sensors, in order to implement a physically compliant behaviour through impedance control⁸. In this way, a desired dynamic behaviour may be imposed on the interaction between the robot end-effector 116 and the environment. For rigid robots, one way in which a robot manipulator such as robot manipulator 100 may be controlled into a desired configuration is obtained using proportional-derivative (PD) control law, with a nonlinear gravity compensation term g(q) which is evaluated online at the current configuration⁹. In the presence of joint elasticity utilizing an on-line gravity compensation is more complex than in the rigid joints scenario. Taking into account the elasticity of motors which are used as actuation units, the PD formulation reference of De Luca et al. (2005) may be augmented. The control law may include a PD action in the space of motor variables, combined with an on-line gravity compensation. Hence, the PD control with on-line gravity compensation is introduced as: ⁸Czametzki, Stefan, Sören Kerner, and Oliver Urbann. “Applying dynamic walking control for biped robots.” Robot Soccer World Cup. Springer, Berlin, Heidelberg, 2009.⁹De Luca, Alessandro, Bruno Siciliano, and Loredana Zollo. “PD control with on-line gravity compensation for robots with elastic joints: Theory and experiments.” Automatica 41.10 (2005): 1809-1819

$${K}_{P} ( {θ}_{d} - θ ) - {K}_{D} \dot{θ} + g ( {θ}_{d} )$$

The variables θ_{d} and θ represent desired and current joint angles, respectively, with g(θ_{d}) the cancellation of gravity at any robot configuration (θ_{d}) during motion. By turning the gains K_{P} and K_{D} gains, the desired compliant behaviour of the arm is modulated. The behaviour may be adapted using either joint space or Cartesian space formulation, but the final control law is always computed in joint space. It is worth noting that the compliant behaviour in the arm may be constrained by the joint position and the torque limits. These limits may be handled by the base 102 to guarantee a whole-body compliant behaviour.

To handle the stability of the robot manipulator 100, the base 102 is also preferably controlled according to a two-stage strategy. When the robot state is in Phase 1 (defined earlier), no action is required since the robot manipulator 100 is highly stable. When the robot state is in Phase 2, motion of the base 102 is triggered. This happens when the magnitude of the external push is large enough to compromise stability even with active compliance in the arm 108, 112. The base response may be composed of a linear and an angular response. The linear velocity command is preferably proportional to the magnitude of the ZMP displacement outside the inner circle C2, and may be expressed as:

$${\dot{X}}_{D} = {K}_{{X}_{b}} \vert δ ZMP \vert$$

Here, \dot{X}_{b} represents a velocity command, and K_{X}_{_{b}} is a scaling factor chosen empirically in order to obtain the desired reactivity.

The angular velocity response preferably depends on three factors:
The torque applied at the shoulder yaw joint being higher than a threshold.
The shoulder yaw joint position reaching its mechanical limits.
The ZMP being located within the outer circle C1, and the line passing through it and the origin of the base is not aligned with any vertex of the support polygon (in the present example, the triangle T).

When pushing on the arm 108, 112 is preferably handled only by a shoulder yaw, due to the kinematics of the arm 108, 112. It may be possible to extrapolate the same strategy applied in the linear case, by defining the two phases in rotational space: a first phase in which the base 102 does not move, and a second phase in which a base 102 reaction strategy is employed. Here, the triggering signal is preferably not dependent on the position of the ZMP, but rather on the torque measured at the shoulder yaw joint. Then, if the value is higher than a predetermined threshold, the base 102 is preferably configured to rotate away from the contact. Then threshold is preferably chosen empirically considering the response of the impedance controller and the desired resultant behaviour. The base 102 target angular velocity may be defined as:

$${\dot{θ}}_{b} = {K}_{{θ}_{b}} , \vert {δτ}_{{q}_{1}} \vert$$

Here, K_{θ}_{_{b}} is a scaling factor chosen empirically to obtain the desired reactivity and δτ_{q}_{₁} is the magnitude of the shoulder yaw torque in excess of the predetermined threshold. As the base 102 rotates, the target joint position 114 of the end-effector 116 in the base frame is preferably updated to preserve the position of the end-effector 116 in the world frame. In order to ensure angular compliance at any time, the shoulder yaw mechanical joint 106 limits must be avoided. This may be done by rotating the base 102 as soon as the limits of the joint 106 are approached. The base 102 target angular velocity is preferably computed so as to regain some margin from the limits of the shoulder yaw joint 16. In such cases, the end-effector 106 position in the world frame cannot be preserved.

When the ZMP is located outside the triangular-shaped support polygon T, the robot manipulator 100 is dynamically unstable. As discussed, the outer circle C1 reduces the stability region (by definition), in order to allow homogeneous reaction strategies in all directions, and to enable the adoption of an additional reaction strategy to guarantee stability in case of failure. Indeed, when the ZMP is located outside the outer circle C1 but inside the triangle T, the robot manipulator 100 remains stable.

In to ensure this, in a secondary strategy, the ZMP is preferably then guided towards the closest vertex of the triangle T support polygon. This may be done by tracking the line passing through the ZMP and the centre of the base, and rotating the base to align it with the closes support polygon vertex.

$${\dot{θ}}_{b}^{t} = - δ r δα {\dot{θ}}_{b , max}$$

Here

$${\dot{θ}}_{b}^{t}$$

the base 102 target angular velocity, and \dot{θ}_{b,max} is the maximum base 102 angular velocity. This control strategy modulates the target angular velocity of the base 102 according to the linear distance of the ZMP from the green zone (δr) and angular distance from the closest vertex (δα). Their values are computed as follows:

$$δ r = \{ \begin{matrix}0 & if {r}_{CoP} < {r}_{g} \\ \frac{{r}_{CoP} - {r}_{g}}{{r}_{o} - {r}_{g}} & if {r}_{g} < {r}_{CoP} < {r}_{o} \\ 1 & if {r}_{CoP} > {r}_{o}\end{matrix}$$

$$and$$

$$δα = \{ \begin{matrix}0 & if \vert {α}_{CoP} - {α}_{v} \vert < {Δα}_{min} \\ \frac{\vert {α}_{CoP} - {α}_{v} \vert - {Δα}_{min}}{{Δα}_{max} - {Δα}_{min}} & if {Δα}_{min} < \vert {α}_{CoP} - {α}_{v} \vert < {Δα}_{max} \\ 1 & if \vert {α}_{CoP} - {α}_{v} \vert > {Δα}_{max}\end{matrix}$$

Here:
r_{CoP} is the CoP (i.e. ZMP) distance from the centre of the mobile base 102.
r_{g} is the radius of the inner circle C2.
rₒ is the radius of the outer circle C1.
α_{CoP} is the angle of the line passing through the CoP (i.e. ZMP) and the centre of the base 102.
αᵥ is the angle of the line passing through the vertex closest to the CoP (i.e. ZMP) and the centre of the base 102.
Δαₘᵢₙ is an angle range about the vertex closest to the CoP (i.e. ZMP) in which no base motion is required.
Δαₘₐₓ is an angle range about the vertex closest to the CoP (i.e. ZMP) in which the base must move to drive the CoP (i.e. ZMP) toward the closest vertex.

In order to avoid high frequency switching behaviour due to signal noise, transition smoothing digital Schmitt triggers may be implemented. The implemented Schmitt trigger may be a logic function that monitors the state of a given signal (e.g. the signal representing the location of the ZMP) and acts as a switching system with a dual threshold. When the input is below a lower threshold, the output is low; when the input is above the upper threshold the output is high, and when the input is between the two, the output retains its value. This is illustrated in FIG. 4B.

A snapshot of the operation of the push handling behaviour with the base reaction switching due to the location of the ZMP (CoP radius) is shown in FIG. 4C, which was obtained from a robot manipulator similar to that in FIG. 1. The band around the stability limit (straight line) denotes the Schmitt trigger switching region. When the ZMP is below the activation zone, the desired base velocity is zero, while above the activation zone the base is employed to move the robot away from the unexpected push. While the ZMP remains in the band, the state of a base activation module does not switch.

Disturbances applied to the tower 104 are preferably handled exclusively by control of the base 102. Indeed, impact forces cannot be absorbed by the tower 102, because as discussed, its structure is rigidly attached to the base 102. The push handling strategy which is preferably adopted by the base 102 is the one presented in the scenario in which a force is applied to the arm 108, 112. The same external push applied from the arm 108, 112 to the tower 104 leads to a more reactive base 102 motion, since there is a direct translation from the external force to the ZMP displacement. Based on empirical data, it is preferable that when push on the arm 108, 112, or the tower 104 causes a displacement of the ZMP outside the inner circle C2, the same strategy (as set out above), is employed.

Conversely, external forces applied to the base 102 itself, may not be observable from the ZMP measurements. The measured ZMP does not contain information about forces applied to the mobile base 102 since the weight sensors are placed between the base 102 and the tower 104. Consequently, pushes on the mobile base 102 are preferably estimated through wheel torque, whose values can estimate the external wrench (Fₓ, F_{y}, τ_{θ}) due to the holonomic property of the base 102. Since the wheels 1021, 1022, 1023 are controlled in velocity, an admittance controller is preferably used to convert any external force to a target base velocity. This enables compliant handling of unexpected external forces applied to the base 102.

We now explain how external forces can be estimated. In some cases, the forces may be estimated as follows.

$${F}_{ext , B} = {H}^{T} ( ( {τ}_{dyn} + {τ}_{fr , w} - {τ}_{fr , f} ) - {τ}_{w} )$$

Here:
τ_{w} is the wheel torque, estimated from motor current sensing (due to the highly reversible gearbox at wheels).
τ_{fr,w} is the wheel torque friction (representable as a Coulomb friction+viscous friction), experimentally measured with the robot suspended. This may vary as a function of the wheel velocities.
τ_{fr,w} is the torque traction. It is experimentally estimated in absence of external forces (once all other components are known). Traction may depend on one, any, or all of: wheel velocities, floor type, mass distribution—which can be neglected and the robot manipulator can be kept static with CoM in its original configuration, roller friction (non-actuated sliding surfaces on the holonomic wheels)—this is included in the estimation, and can't be independently measured.
τ_{dyn} is computed according to A\ddot{q}+C(\dot{q})\dot{q}, where A is the inertia matrix and C is the Coriolis matrix¹⁰. The value depends on robot inertia reflected at the wheels, robot mass, wheel velocities, and wheel accelerations.
H is the Jacobean matrix which returns the wheel velocities based on the twist of the base. ¹⁰M. Velasco-Villa, H. Rodriguez-Cortes, I. Estrada-Sanchez, H. Sira-Ramirez and J. A. Vazquez (Apr. 1, 2010). Dynamic Trajectory-Tracking Control of an Omnidirectional Mobile Robot Based on a Passive Approach, Advances in Robot Manipulators, Ernest Hall, IntechOpen, DOI: 10.5772/9665.

The torque at the wheel may be approximated from motor current, using the following relation:

$${τ}_{w} = {i}_{m} {k}_{r} n η$$

Here:
iₘ is the motor current.
kᵣ is the motor torque constant.
η is the gearbox mechanical efficiency (approximated to a constant).
n is the gearbox reduction ratio.

For simplicity, rather than modelling τ_{fr,w} and τ_{fr,f} through experimental curve fitting, first approach may include experimentally identifying a threshold to detect external forces. Since τ_{fr,w} and τ_{fr,f} are velocity dependent, they may be determined by running a set of different motions (at the highest velocity) and identifying the maximum wrench value experiences in the absence of any external forces. This represents a threshold Fₜₕᵣ which enables one to discern when an external force is applied to the robot manipulator. This threshold must be defined for each of a plurality of floor types, though.

Having done so, the external force may be estimated as follows:

$${F}_{ext , B} = {H}^{T} ( {τ}_{dyn} - {τ}_{w} ) - {F}_{thr}$$

This avoids a more complex friction determination process.

Another method of determining the external force which does not rely on the measurement or determination of wheel accelerations is also set out below. To do so, the De Luca external torque estimation approach may be used, in a manner which is modified for the present content¹¹. ¹¹De Luca, A., & Mattone, R. (2005). Sensorless robot collision detection and hybrid force/motion control. Proceedings—IEEE International Conference on Robotics and Automation, 2005 (April), 999-1004. https://doi.org/10.1109/ROBOT.2005.1570247

The dynamics of the system may be represented as follows:

$${τ}_{m} + {τ}_{ext} = M ( q ) \ddot{q} + C ( \dot{q} ) q$$

Where:
M(q) is the inertia matrix.
C(\dot{q}) is the Coriolis matrix.
τₘ is the motor torque.
τₑₓₜ is the external torque.

Then, the momentum observer may be written as:

$$r = {K}_{0} ( M ( q ) \dot{q} ) - \int ( {C}^{T} ( \dot{q} ) \dot{q} + {τ}_{m} + r ) dt )$$

Where:
r is the residual
K₀ is the residual gain

This leads to:

$$\dot{r} = {K}_{0} ( {τ}_{ext} - r )$$

This equation describes a stable dynamic converging to a desired vector or external forces called residuals. Experiments have shown that determination of the external forces in this manner give rise to reliable results. Hereafter, external torques which are based on residuals are denoted \hat{τ}ₑₓₜ.

When the external forces detected using the procedure depicted in the previous section are above a minimum threshold value (selected empirically based on the desired level of reactivity and compliance), the mobile base platform will move away from the disturbance. The behaviour of the mobile base is modulated using an admittance controller, designed to provide compliance with respect to the external force (i.e., leads the robot away from the contact). The desired dynamics can be expressed as:

$${M}_{des} {\ddot{X}}_{b} + {B}_{des} {\dot{X}}_{b} = {F}_{ext , x}$$

Here M_{des} and B_{des} are the desired mass and damping of a virtual compliant system, and F_{ext,x} is the time dependent force disturbance applied to the system. Assuming the external force is close to a perfect impulse, the above equation may be solved to produce the desired trajectory:

$${X}_{b} ( t ) = {X}_{b , 0} + \frac{{F}_{ext , x}}{{B}_{des}} ( 1 - {e}^{- \frac{{B}_{des}}{{M}_{des} t}} )$$

Here X_{b,0} is the position of the base when the external push was detected.

In the implementation being discussed presently, the desired dynamics are used to obtain the desired next step velocity which is then used as a command input for the mobile base 102. The full operational logic of the admittance controller is encoded as a finite state machine (FSM) as follows.

### Mode 0:

The admittance controller is actively monitoring the detected force readings.

### Mode 1:

When a push on the base is detected, the admittance behaviour is triggered, and the platform moves aware form the pish according to the desired system properties (M_{des} and B_{des}).
At the same time, an odometry module starts tracking the distance travelled:

$$d = \sum {d}_{t} = \sum {\dot{X}}_{b} Δ t$$

Here, Cartesian space velocities of the base are obtained from the wheel space velocities using the transformation map H.

### Mode 2

Once the effect of the external push has been eliminated (the platform has come to a stop).
The platform has a short waiting time before transitioning to the next mode, in order to remove any effects of residual readings in the sensors.

### Mode 3

The system will use the computed travelled distance and retrace its original position.
The velocity of the platform in this stage is directly proportional to the magnitude of the displacement caused by the admittance controller in Mode 1.

### Mode 4

Once the original position has been recovered (within a given accuracy margin) the system stops and re-enters Mode 0.
As in Mode 2, the system has a short settling time before reset to eliminate any residual readings.

To evaluate wheel torque sensing through current readings, the gearbox efficiency was experimentally estimated. In order to do so, the platform was suspended and the torque at each wheel was measured at discrete intervals by means of a pre-settable torque screwdriver. Once the maximum applicable torque on the screwdriver was set, the tool was fixed and the wheel actuated. At the instant at which the wheel was free to move, the motor current value was registered. This made it possible to compare expected and measured torques at the wheel, and thereby to identify the real gearbox efficiency (0.67). This was experimentally validated on all wheels.

The external force estimation may be experimentally tuned for static scenarios where a constant threshold is used to detect external forces. This can enable the avoidance of false detection due to noise, and enables a very fine sensitivity to external pushes. To extend external force detection in dynamic scenarios, wheel friction (velocity dependent) and traction friction (velocity and floor dependent) should be identified.

The admittance control reactivity depends on several tuning factors (force threshold for activation, the desired system properties M_{des} and B_{des}). Since the external force estimation is experimentally tuned for static scenarios, the admittance controller may only be activated to counteract pushes on the base in those situations. While moving away from the external force, the base may follow the admittance controller law for modulating the velocity. The return to the original position of the base accuracy may be heavily influenced by the wheel odometry performance. This may affect the estimation of the distance covered on both travelling directions.

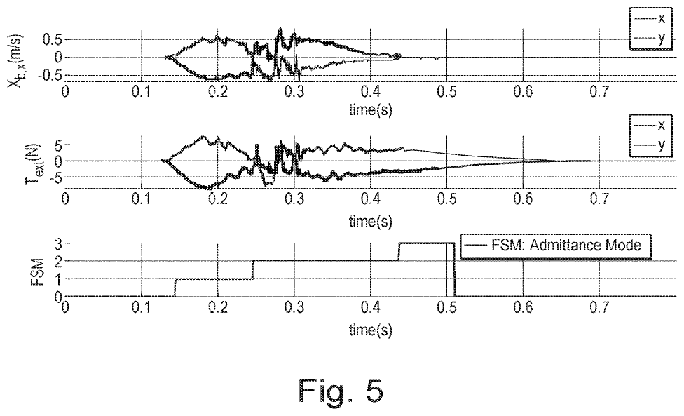

The admittance controller operation is showcased in FIG. 5 with the base velocity commands (top) corresponding to the detected external forces (middle) displayed alongside the respective modes of the Finite State Machine (FSM) described in the previous section. These results were obtained from a robot manipulator similar to that shown in FIG. 1. We note that Modes 2 and 4 are defined just for the purpose of showcasing the approach on the robot and can easily be considered part of the Modes 1 and 3, respectively.

### Integration

The above disclosure sets out how each of the stability-aware acceleration and the push handling may be implemented in a specific, non-limiting implementation. A focus of the present invention is the integration of these strategies into a single control scheme.

In order to integrate the maximum admissible acceleration strategy with movement of the mobile base 102 under the various push handling scenarios presented above, after a mobile base 102 velocity command is generated, a maximum accessible acceleration module is preferably configured to determine whether the mobile base 102 velocity command will give rise to an acceleration which exceeds a predetermined threshold. If so, the maximum accessible acceleration module may be configured either to prevent the mobile base 102 velocity command from being executed, or to modify the command to ensure that the acceleration does not exceed the predetermined threshold.

Next, we discuss the integration of the various push handling scenarios (on arm, tower and base). The mobile base 102 linear response strategies to pushes on the arm 108, 112, tower 104 and base 102 are inherently compatible. Preferably, these may be integrated through the selection of predetermined activation thresholds in order to achieve the desired reactivity/compliance, as discussed elsewhere in this application. In the current implementation, the pushes on the arm 108, 112 and tower 104 will cause the mobile base 102 to move away from the external disturbance, while the push on the base 102 will also allow the system to return to the original position (within the accuracy of the wheel odometry measurements).

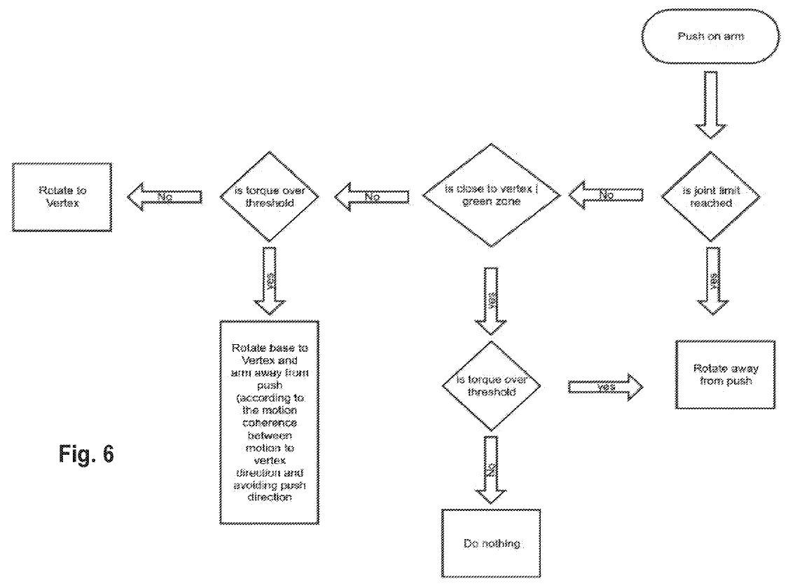

The mobile angular response strategies to pushes on the arm 108, 112 and tower 104 are more complex, and special considerations have to be taken in their integration. As their effect might lead to conflicting strategies, their activation must be prioritised as set out in the flowchart of FIG. 6. Consider a push that displaces the ZMP far from a support polygon vertex and that moves the shoulder yaw joint close to its mechanical limits. The target velocities required for each task might be in opposition and lead to undesired platform behaviour. To overcome this problem, priorities are assigned to each strategy.

First the shoulder yaw position joint limits are checked, as the arm compliance is desired at all times and in any direction. In case the ZMP is in the inner circle C2, if the shoulder yaw is far from its mechanical limits then the torque limits are simply handled with secondary priority. On the contrary, when the ZMP is in the outer circle C1 (but not within the inner circle C2), if the shoulder yaw is far from its mechanical limits, joint torque and ZMP alignment with the closest support polygon vertex are evaluated together. If only one of the two strategies is triggered (the joint torque overcome the torque threshold or the ZMP is getting too far from the closest vertex), the corresponding behaviour is adopted. If instead both strategies are triggered at the same time, the base 102 target velocity of each strategy is evaluated. To solve both objectives, which are preserve stability and avoid the push on the arm, the target velocities are used as follows:
The mobile base 102 is only driven according to the vertex distance—the motion to the vertex takes priority over the torque at the shoulder yaw.
The arm 108, 112 target position is updated as follows:
   If both strategy target velocities have the same sign, the arm 108, 112 is kept at its configuration so that it moves away from the push since the base 102 rotates in a coherent direction.
   If the two target velocities have opposite signs, then the arm 108, 112 is updated twice as fast as the angular base 102 velocity in the opposite direction, so to avoid the push on the arm 108, 112.

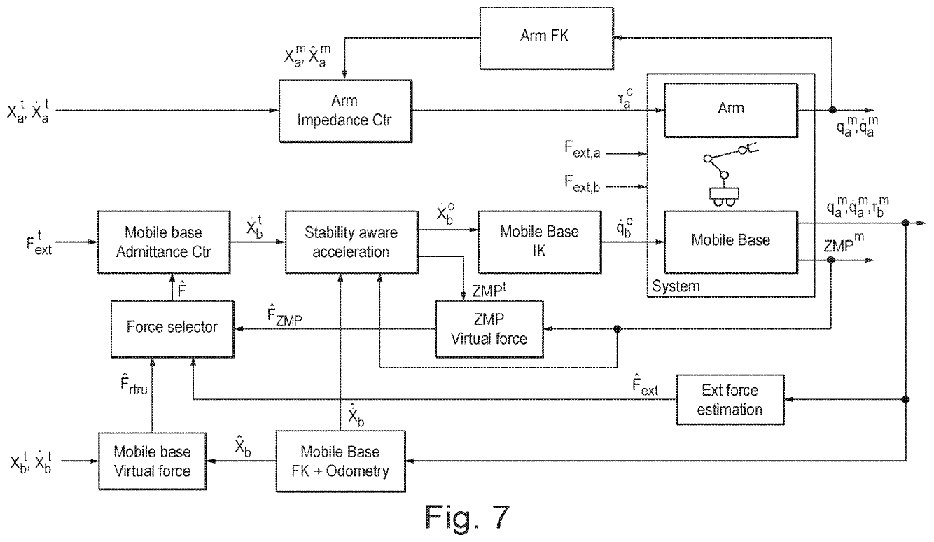

FIG. 7 is a flowchart illustrating an overall control scheme which incorporates various aspects of the present invention described in detail in the “Summary” section of this patent application. The process may repeat, e.g. 100 times per second. At a high-level, it will be noted that according to the scheme, the arm 108, 112 and the base 102 are independently controlled. In this particular implementation, the arm 108, 112 is controlled using an impedance controller (“Arm Impedance Ctr” block), and the base 102 is controlled using an admittance controller (“Mobile base admittance Ctr” block). The latter enables the integration of different control strategies through the same interface. Since wheels 1021, 1022, 1023 are controlled in velocity, the admittance controller is used to convert any input force into a base 102 velocity, in order to enable the handling of unexpected external forces applied to the robot manipulator 100. It is important to note that it is equally feasible for the arm 108, 112 to be controlled using an admittance controller, and for the base 102 to be controlled using an impedance controller—such arrangements are still covered by the present invention. In order to add trajectory tracking, mobile bas 102 tracking errors in the Cartesian space are converted to virtual forces (“Mobile base Virtual force” block). The same approach is used for ZMP tracking to ensure dynamic stability “ZMP Virtual force” block). The choice between the virtual or estimated external force is based on priority and managed by the “Force selector” block. The ZMP virtual force has priority over the other forces, because its objective is to maintain dynamic stability. Once stability is ensured, undesired external forces are minimized and/or avoided. Then, when external forces are no longer present, the platform moves back to the target trajectory. Any target velocity computed from the mobile base 102 admittance controller is modulated by the “Stability aware acceleration” to ensure a dynamically stable motion is executed by the base 102. The corresponding target ZMP is computed to evaluate the deviation between the expected and measured ZMP at the next control step. This method can cope with multiple external forces applied simultaneously at the arm 108, 112, and at the mobile base 102.

The first control loop we discuss is located at the upper part of FIG. 7, and pertains to the control of the arm 108, 112. The arm impedance controller receives an input

$$( {X}_{a}^{t} , {\dot{X}}_{a}^{t} ) ,$$

denoting a target position and target velocity of the arm respectively. Subsequently, the arm impedance controller is configured to convert the target input

$$( {X}_{a}^{t} , {\dot{X}}_{a}^{t} )$$

into a torque command

$${τ}_{a}^{c} .$$

This torque command

$${τ}_{a}^{c}$$

is received by a motion system (not shown) of the arm 108, 112, a joint of which (preferably the shoulder joint 106, via which it is attached to the tower 104) then executes the motion according to the torque command

$${τ}_{a}^{c} .$$

Then, a sensor (not shown) in e.g. the joint 106 is configured to determine the resulting position and velocity

$$( {q}_{a}^{m} , {\dot{q}}_{a}^{m} )$$

of the joint 106 in response to the executed torque. The results of this measurement are then fed into an arm forward kinematics module in order to determine the actual (i.e. “measured”) position and velocity

$$( {X}_{a}^{m} , {\dot{X}}_{a}^{m} )$$

of the arm 108, 112. This measured position and velocity

$$( {X}_{a}^{m} , {\dot{X}}_{a}^{m} )$$

is then fed into the arm impedance controller in order to enable it to adjust the torque command

$${τ}_{a}^{c}$$

in order to ensure that the arm 108, 112 is able to achieve its target position and velocity

$$( {X}_{a}^{t} , {\dot{X}}_{a}^{t} ) .$$

As well as the torque command

$${τ}_{a}^{c} ,$$

the arm 108, 112 may also be subject to an external force F_{ext,a}. If this is the case, the measured position and velocity

$$( {q}_{a}^{m} , {\dot{q}}_{a}^{m} )$$

of the joint 106, and the resulting measured position and velocity

$$( {X}_{a}^{m} , {\dot{X}}_{a}^{m} )$$

of the arm 108, 112 will not reflect the target input

$$( {X}_{a}^{t} , {\dot{X}}_{a}^{t} ) .$$

In response to the applied external force F_{ext,a} on the arm 108, 112, which is detected via the measured position and velocity

$$( {q}_{a}^{m} , {\dot{q}}_{a}^{m} )$$

of the joint 106, the arm impedance controller may then generate instructions which cause the arm 108, 112 to be compliant in response to the external force. In other words, as long as the applied force F_{ext,a} to the arm 108, 112 does not act to jeopardize the stability of the robot manipulator 100 (on which more later), the arm 108, 112 will simply move along with the applied force F_{ext,a}. This may be effected by controlling the proportional and derivative gains of the impedance controller such that the joint 106 does not provide any resistance to the applied force F_{ext,a}.

The lower half of the scheme shown in FIG. 7 relates to the control of the base 102. Central to the control of the base 102 is a force selector, which controls which of three forces should be acted upon:
(i) A mobile base virtual force \hat{F}ᵣₜᵣₙ, which is a virtual force which is calculated will give rise to a position and velocity which is in line with an input target base position and velocity

$$( {X}_{b}^{t} , {\dot{X}}_{b}^{t} )$$

received from e.g. an external planner. It will be noted that the input in terms of position and velocity

$$( {X}_{b}^{t} , {\dot{X}}_{b}^{t} )$$

is converted to a force \hat{F}ᵣₜᵣₙ so that the selector can compare three similar quantities.
(ii) An external force \hat{F}ₑₓₜ, which is an external force applied to the base 102. It will be appreciated that the value of this force Fₑₓₜ is not known, as it is an unexpected, applied force to the base 102. So, the value of this force is estimated using the Ext force estimate module shown in the control scheme.
(iii) A virtual ZMP force \hat{F}_{ZMP}, which is another virtual force which is estimated as the effective force on the base 102 which would cause an observed motion of the ZMP. Crucially, as explained in detail about, this virtual force \hat{F}_{ZMP} is the force which may lead to the loss of dynamic stability of the robot manipulator 100, as it may lead to movement of the ZMP out of the stability region.

We start our discussion at the Mobile base Admittance Ctr block. As its input, it receives the force \hat{F} out from the force selector (we will discuss how this is generated later). In its capacity as an admittance controller, it then generates a target velocity

$${\dot{X}}_{b}^{t}$$

for the base 102. Then, as discussed previously, this target velocity

$${\dot{X}}_{b}^{t}$$

may be input to the stability aware acceleration module, which checks, e.g. using a process set out earlier in this patent application, whether adoption of the target velocity

$${\dot{X}}_{b}^{t}$$

will give rise to destabilization as a result of the accelerations required to reach the velocity

$${\dot{X}}_{b}^{t} .$$

The stability aware acceleration module may further receive a measured location of the ZMP ZMP^{m}. The stability aware acceleration module may use the current value of the base velocity and the ZMP location in order to compute the future base velocity and ZMP position under the current command. If the command would result in an unstable ZMP position, the value of the command is truncated to the maximum allowed value. This dependency is captured using the LIPM described elsewhere in this application. The stability aware acceleration module may also output a target ZMP position ZMP^{t}, under the command which has been checked for stability.

The output of the stability aware acceleration module is then a base velocity command

$${\dot{X}}_{b}^{c} .$$

The base velocity command

$${\dot{X}}_{b}^{c}$$

is a velocity in Cartesian space. This is then converted, by the mobile base inverse kinematics module into a joint motion command \dot{q}_{b}^{c} which is received by a motion system (not shown) of the base 102, which then causes the base 102 to execute the desired motion. There are 3 motors/actuators in the base, one for each wheel. From a control perspective, they are “active control degrees of freedom”, functioning as any other motor/actuator in the joints of the arm. Using the direct and inverse kinematics of the base the movement of the wheels' motors can be transformed into movement of the base.

Then, the response of the joints, in terms of position, velocity and torque

$$( {q}_{b}^{m} , {\dot{q}}_{b}^{m} , {τ}_{b}^{m} )$$

is measured, as well as the location of the ZMP, ZMP^{m}. From the ZMP measurement, the ZMP Virtual force module determines the virtual ZMP force \hat{F}_{ZMP}, which is then sent to the force selector. The response of the joints

$$( {q}_{b}^{m} , {\dot{q}}_{b}^{m} , {τ}_{b}^{m} )$$

is then transmitted to the external force estimation module, which uses that information, for example using the methods outlined elsewhere in this application, to estimate a value of the external force \hat{F}ₑₓₜ, which itself is then transmitted to the force selector.

Finally, using mobile base forward kinematics and odometry, an estimated position \hat{X}_{b} and velocity \dot{\hat{X}}_{b} of the base 102 are determined. The estimated position \hat{X}_{b} and velocity \dot{\hat{X}}_{b} of the base 102 is then transmitted to the mobile base virtual force module, to inform its calculation of the mobile base virtual force \hat{F}ᵣₜᵣₙ\hat{F}ᵣₜᵣₙ may be calculated as follows:

$${\hat{F}}_{rtrn} = {K}_{p , traj} ( {X}_{b}^{t} - {\hat{X}}_{b} ) - {K}_{d , traj} ( {\dot{X}}_{b}^{t} - {\hat{\dot{X}}}_{b} )$$

Here, K_{p,traj} and K_{d,traj} are empirically determined constants, based on the desired behaviour of the base.

At this point, the force selector has received the three force estimates \hat{F}ᵣₜᵣₙ, \hat{F}_{ZMP}, and \hat{F}ₑₓₜ. The force selector preferably prioritizes these forces in the following order (from highest to lowest priority):
(i) Virtual ZMP force \hat{F}_{ZMP},
(ii) External force \hat{F}ₑₓₜ
(iii) Mobile base virtual force \hat{F}ᵣₜᵣₙ

This is because the virtual ZMP force \hat{F}_{ZMP} is the force which influences the stability of the robot manipulator 100, so given that dynamic stability of the robot manipulator 100 is the focus of the invention (since it directly affects the safety of the device in the home, for example, and determines whether the device will fall), it takes precedence. Then, if the stability of the robot manipulator 100 is not at issue (e.g. despite the virtual ZMP force \hat{F}_{ZMP}, the ZMP still remains in the inner circle C2) the force selector prioritizes the external force \hat{F}ₑₓₜ so that the base 102 responds to the external force by moving away from it, thereby reducing further the risk of toppling. Only then, when there is no risk of loss of dynamic stability, and the effect of the external force \hat{F}ₑₓₜ has been mitigated, does the base 102 continue to follow the target trajectory.

The output force \hat{F} of the force selector may be calculated using the following formula:

$$\hat{F} = α \cdot {\hat{F}}_{Z M P} + ( 1 - α ) ( 1 - β ) {\hat{F}}_{rtrn} + β ( 1 - α ) {\hat{F}}_{e x t}$$

Here, α, which ranges from 0 to 1 is a value which parametrizes the location of the ZMP relative to a predetermined threshold, at which point there is a risk of loss of dynamic stability, and the base 102 must move to address it. When it is determined that the threshold is outside e.g. the inner circle C2 or the inner circle C1, the value of α is preferably 1, which means that \hat{F} is equal to \hat{F}_{ZMP}, and the motion of the base 102 is planned solely to address the lack of dynamic stability (or impending lack of dynamic stability). On the other hand, if there is no risk of loss of dynamic stability, the value of α may be 0, in which case, the \hat{F}_{ZMP} term vanishes.

Similarly, β, which also ranges from 0 to 1, is a value which parameterizes the proximity of the external force \hat{F}ₑₓₜ to a predetermined threshold, at which point the base 102 needs to move in order to address the effect of the external force \hat{F}ₑₓₜ. If the value of α is 0, and it is determined that the value of \hat{F}ₑₓₜ exceeds a threshold to the extent that action must be taken, the value of β is 1, so the \hat{F}ᵣₜᵣₙ term vanishes, and the motion of the base 102 is controlled solely to respond to the external force \hat{F}ₑₓₜ. On the other hand, if there is no external force, or if it is negligibly small, the \hat{F}ₑₓₜ term vanishes.

From this it may be seen that the \hat{F}ᵣₜᵣₙ term takes precedence only if there is no contribution from the \hat{F}_{ZMP} and \hat{F}ₑₓₜ terms.

When the values of α and β are between 0 and 1, the \hat{F} term is sum of all three contributions. After it has been calculated by the force selector, the process returns to where our description began.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A robot manipulator comprising:
a base;
an arm connected to the base via at least a shoulder joint; and
a control system comprising a dynamic stability determination module,
wherein:
the dynamic stability determination module of the control system is configured to determine whether a dynamic stability criterion is met;
if the dynamic stability criterion is met, the arm is configured to respond compliantly to a detected applied force; and
if the dynamic stability criterion is not met, the control system is configured to cause motion of the base in a direction of the applied force.

2. The robot manipulator of claim 1, wherein:
the dynamic stability determination module of the control system is configured to determine whether the dynamic stability criterion is met in response to an applied external force on the shoulder joint or the arm of the robot manipulator.

3. The robot manipulator of claim 1, wherein:
the dynamic stability determination module of the control system is configured to determine whether the dynamic stability criterion is met at fixed time intervals.

4. The robot manipulator of claim 1, further comprising:
a tower connected at a proximal end to the base, and at a distal end to the shoulder joint, the distal end being opposite the proximal end.

5. The robot manipulator of claim 1, wherein:
the dynamic stability determination module of the control system is configured to:
determine a location of a zero-moment point (ZMP) of the robot manipulator; and
determine whether the dynamic stability criterion is met based on the location of the ZMP of the robot manipulator.

6. The robot manipulator of claim 5, wherein either:
The dynamic stability criterion is that the ZMP of the robot manipulator is located above a predetermined support region, the predetermined support region being bounded by a predetermined support region boundary; or
the dynamic stability criterion is that the ZMP of the robot manipulator is located above a point within the predetermined support region which is at least a threshold distance from the predetermined support region boundary.

7. The robot manipulator of claim 6, wherein:
a dynamic stability region may be defined as a region over which the ZMP must be located in order for the robot manipulator to be dynamically stable, the dynamic stability region being bounded by a dynamic stability region boundary; and
the predetermined support region does not extend outside the dynamic stability region boundary.

8. The robot manipulator of claim 6, wherein:
the base comprises three or more floor-contacting supports, a contact points of the respective floor-contacting supports with the floor defining a support polygon region; and
the predetermined support region is a circle inscribed within the support polygon region.

9. The robot manipulator of claim 8, wherein:
the base comprises three floor-contacting supports defining a support triangle region; and
the predetermined support region is in a circle defined by the support triangle region.

10. The robot manipulator of claim 1, wherein:
the shoulder joint is located at a proximal end of the arm; and
the robot manipulator further comprises an end-effector located at a distal end of the arm, opposite from the proximal end of the arm; and
the control system is configured to:
receive target trajectory instructions defining a target trajectory of the end-effector; and
control a motion of one or more of the base and the shoulder joint in order to cause the end-effector to execute the target trajectory defined in the target trajectory instructions.

11. The robot manipulator of claim 10, wherein:
the control system is configured to generate:
first instructions defining a target motion of the shoulder joint; and
second instructions defining a target motion of the base,
such that execution of the target motion of the shoulder joint according to the first instructions and execution of the target motion of the base according to the second instructions causes the end-effector to execute the target trajectory as defined in the target trajectory instructions.

12. The robot manipulator of claim 1, wherein:
the control system comprises an impedance controller configured to cause the arm to become compliant in response to a determination that the dynamic stability criterion is met;
the impedance controller is configured to cause the arm to become compliant by decreasing a proportional-derivative gain.

13. The robot manipulator of claim 1, wherein:
in response to the detection of the applied force, the control system is preferably configured to determine whether the applied force exceeds a magnitude threshold;
if the control system determines that a magnitude of the applied force does not exceed the magnitude threshold, the control system is configured to control a motion of one or more of the base and the shoulder joint to cause the-effector to execute a target trajectory; and
if the control system determines that the magnitude of the applied force exceeds the magnitude threshold, then the control system is then configured to determine whether the dynamic stability criterion is met.

14. The robot manipulator of claim 11, wherein:
the control system is configured to determine:
a virtual ZMP force which, when applied to the base, would either counteract any observed motion of a ZMP of the robot manipulator, or act to move the ZMP of the robot manipulator back to within a predetermined support region;
an external force applied to the base; and
an effective force which, when applied to the base, would cause the base to execute the target motion of the base according to the second instructions;
the control system further comprises a force selector configured to receive data defining the virtual ZMP force, the external force applied to the base, and the effective force, and to determine a target force based on the data.

15. The robot manipulator of claim 14, wherein:
an admittance controller of the control system is configured to receive the target force as a target input force, and is configured to convert the target input force into a base velocity command; and to transmit the base velocity command to a motion system of the base to cause it to execute the base velocity command.

16. A 3D cleaning device comprising the robot manipulator of claim 1, the robot manipulator comprising an end-effector comprising one or more of the following: a vacuum cleaning attachment, a mopping attachment, a brush and a wiper.
